(19) United States
(12) Patent Application Publication
(10) Pub. No.: US 2022/0134638 A1
(43) Pub. Date: May 5, 2022

(54) METHOD FOR PRINTING AN OPTICAL COMPONENT

(71) Applicant: LUXEXCEL HOLDING B.V., Eindhoven (NL)

(72) Inventor: Tom Verheyen, Eindhoven (NL)

(21) Appl. No.: 17/431,831

(22) PCT Filed: Feb. 19, 2020
(86) PCT No.: PCT/EP2020/054405

§ 371 Date: Aug. 18, 2021

(30) Foreign Application Priority Data
Feb. 20, 2019 (EP) 19158363.2

(51) Int. Cl. B29C 64/112; B33Y 10/00; B29D 11/00; B29C 35/08

(52) U.S. Cl. CPC B29C 64/112; B33Y 10/00; B33Y 80/00; B29C 35/0805; B29D 11/00442

(57) ABSTRACT

A method for printing a three-dimensional optical component comprising a boundary portion and a remaining portion, comprising the following steps: building up the three-dimensional component from layers of printing ink, wherein each layer is obtained through a targeted placement of droplets of printing ink at least partially side by side, wherein the boundary portion of the three-dimensional component is printed during a boundary defining step followed by a filling step during which the remaining portion is printed.

### BACKGROUND

The present invention relates to a method for printing a three-dimensional optical component comprising a boundary portion and a remaining portion, wherein the three-dimensional optical component is build up from layers of printing ink through a targeted placement of droplets of printing ink at least partially side by side.

Printing three-dimensional optical components such as ophthalmic lenses, mirrors and the like is known from the prior art. The optical structures are built up layer by layer through a targeted placement of droplets of printing ink. The droplets are ejected towards a substrate by ejection nozzles of the print head of an inkjet printer. Printing of optical components is particularly demanding due to the high accuracy required. When printing optical components with edges, such as ophthalmic lenses for example, with current state of the art methods, the fluid characteristics of the printing ink result in unwanted deformations of the printed component. Instead of a sharp edge, a bulge or protrusion is formed, resulting in a deviation of the overall shape of the printed component from its intended shape and hence, compromising the optical quality of the component.

### SUMMARY

It is a purpose of the present invention to provide a method for printing three-dimensional optical components with sharp edges, preventing the formation of material bulges and protrusions through fluid characteristics of the used printing ink.

According to the present invention, this object is achieved by a method for printing a three-dimensional optical component, in particular an ophthalmic lens, comprising a boundary portion and a remaining portion, comprising the following steps: building up the three-dimensional component from layers of printing ink, wherein each layer is obtained through a targeted placement of droplets of printing ink at least partially side by side wherein the boundary portion of the three-dimensional component is printed during a boundary defining step followed by a filling step during which the remaining portion is printed.

This object is likewise achieved by a method for printing a three-dimensional optical component, in particular an ophthalmic lens, comprising a boundary portion and a remaining portion, comprising the following steps: virtually slicing the three-dimensional optical component into two-dimensional slices; building up the three-dimensional component from layers of printing ink corresponding to these slices, wherein each layer is obtained through a targeted placement of droplets of printing ink at least partially side by side, wherein at least one slice comprises a boundary area and a remaining area constituted by the areas of the at least one slice forming part of the boundary portion and remaining portion, respectively, and

wherein a boundary area of the layer corresponding to the at least one slice is printed during a boundary defining step followed by a filling step during which a remaining area of the layer corresponding to the at least one slice is printed.

The concept underlying these two methods is to split the printing of a critical area of the optical component into two steps: a first step, during which a defined boundary is provided and a second step, during which the area or volume adjoining this boundary is filled. This can either be done layer-wise or for a section or the entire optical component. Through the provision of a defined boundary, the otherwise present bulge formation is reduced or entirely inhibited. With the presented methods, it is advantageously possible to print a three-dimensional optical component, in particular an ophthalmic lens, with defined, sharp edges and hence of an increased optical quality.

According to a preferred embodiment, the boundary defining step and filling step are repeated for all layers corresponding to slices forming part of the boundary portion and/or the remaining portion. In this way, the boundary portion and the remaining portion are built up layer by layer, wherein for each layer, a defined boundary is provided by the boundary area printed in the boundary defining step of that layer and subsequently filled during the filling step of that layer. Hence, detrimental deformations due to the fluid characteristics of the printing ink are advantageously avoided.

In the sense of the present invention, printing of an optical component comprises building up the component from layers of printing ink. These are obtained through a targeted placement of droplets of printing ink at least partially side by side. The droplets of printing ink are ejected from the nozzles of a print head, typically towards a substrate. The printing ink preferably comprises a translucent or transparent, photo-polymerizable monomer. The deposited droplets may or may not be cured at intervals through exposition to ultraviolet radiation.

Optical components in the sense of the present invention comprise lenses, in particular ophthalmic lenses. Ophthalmic lenses comprise concave, convex, biconcave, biconvex and meniscus lenses. Ophthalmic lenses in the sense of the present invention also comprise multifocal lenses.

According to a preferred embodiment, the boundary portion comprises a, preferably sharp, edge. Preferably, the boundary portion comprises a steep, preferably vertical, section. Additionally or alternatively, the boundary portion at least partially surrounds the remaining portion. Here and in the following, “vertical” refers to the direction of the gravitational field. By printing sharp edges of the optical component using separate printing steps for the boundary and remaining portions of that edge, prevents a bulging of the deposited material due to the fluid characteristics of the printing ink.

According to a preferred embodiment, the deposited droplets of printing ink are at least partially cured using UV light. Through curing, preferably at least one component of the printing ink is at least partially photo-polymerized. In this way, the cured printing ink is pinned, i.e. its viscosity advantageously increased.

According to a preferred embodiment, at least part of the boundary portion is cured using a higher curing energy than at least part of the remaining portion. The curing energy defines the extent to which the cured printing ink is polymerized and hence pinned. The boundary portion hence defines a stable boundary for the printing ink deposited in the remaining portion, advantageously preventing the formation of bulges, in particular at edges of the optical component.

According to a preferred embodiment, the deposited droplets are cured using UV light of locally varying intensity. Preferably, the spatial distribution of the intensity of the UV light is chosen such that a defined boundary is formed in the boundary portion of the optical component.

According to a preferred embodiment, the printing properties of the boundary defining step differ from the printing properties of the filling step. Printing properties are e.g. printing speed, printing ink, curing properties such as intensity and wave length of as well as exposure time to the used UV light.

According to a preferred embodiment, a defined time span elapses between the boundary defining step and the filling step during which the printing ink deposited during the boundary defining step changes its chemical and/or physical properties. Preferably, the time span is chosen such that the balance between printing speed and pinning of the deposited printing ink is optimized.

According to the present invention, this object is also achieved by a method for printing a three-dimensional optical component, in particular an ophthalmic lens, comprising a boundary portion, a remaining portion and an inner portion, comprising the following steps: building up the three-dimensional component from layers of printing ink by printing, wherein each layer is obtained through a targeted placement of droplets of printing ink at least partially side by side, wherein
in a first inner portion printing step a first layer of the inner portion is printed,
in a first boundary printing step, posterior to the first step, a posterior layer of the inner portion and a first layer of the boundary portion is printed,
in subsequent steps, posterior to the first boundary printing step, subsequent layers of the inner portion and the boundary portion are printed,
in a filling step, posterior to the subsequent steps, the remaining portion is printed between the boundary portion and the inner portion.

The concept underlying this method is to split the printing of a critical area of the optical component into two steps: a first step, during which a defined boundary is provided disposed at a distance from the inner portion and a step, during which the area or volume adjoining this boundary is filled. The filling can either be done layer-wise or for a section or the entire optical component. Through the provision of a defined boundary, the otherwise present bulge formation is reduced or entirely inhibited. With the presented method, it is advantageously possible to print a three-dimensional optical component, in particular an ophthalmic lens, with defined, sharp edges and hence of an increased optical quality.

Preferably, the placed droplets of printing ink of the boundary portion and/or of the inner portion and/or of the remaining portion are pin cured. Pin curing in the sense of the invention is partially curing, preferably by UV-light.

According to a preferred embodiment, in the first boundary printing step a third or later layer of the inner portion is printed, wherein in the first boundary printing step preferably a sixth or later layer of the inner portion is printed. It has been found that this creates a time gap between the printing of the inner portion and the boundary portion, which has a positive effect on the stability of the boundary portion.

According to a preferred embodiment, in the first boundary printing step a 20th or earlier layer of the inner portion is printed, wherein in the first boundary printing step preferably a tenth or earlier layer of the inner portion is printed. It has been found, that

### BRIEF DESCRIPTION OF THE DRAWINGS

FIGS. 1a, 1b and 1c schematically illustrate a printing method according to the state of the art.

FIGS. 2a and 2b schematically illustrate a printing method according to an exemplary embodiment of the present invention.

FIGS. 3a and 3b schematically illustrate a printing method according to an exemplary embodiment of the present invention.

### DETAILED DESCRIPTION

The present invention will be described with respect to particular embodiments and with target to certain drawings but the invention is not limited thereto but only by the claims. The drawings described are only schematic and are non-limiting. In the drawings, the size of some of the elements may be exaggerated and for illustrative purposes may not be drawn to scale.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

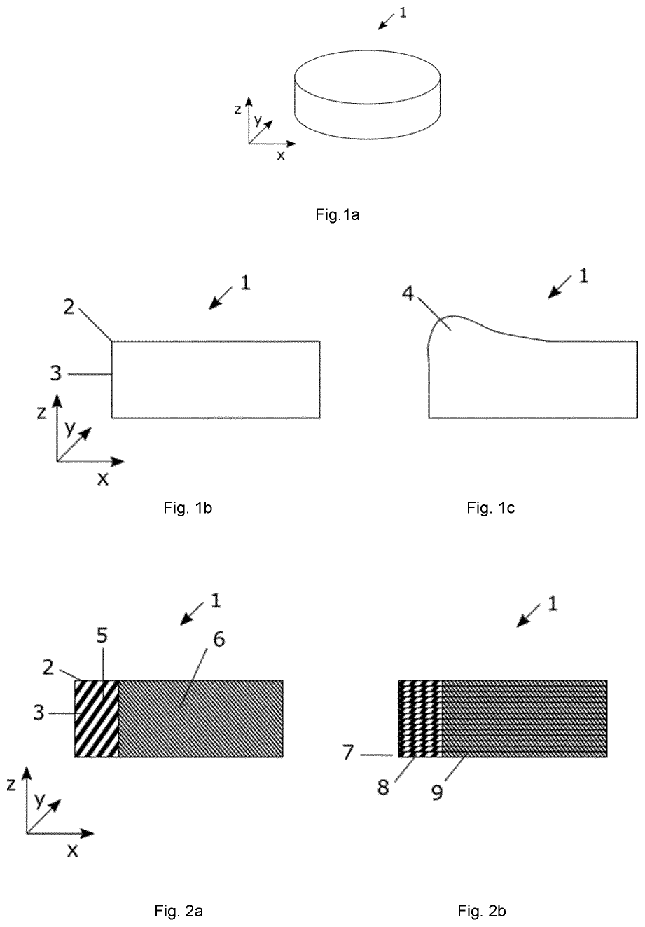

In FIGS. 1a, 1b and 1c a printing method according to the state of the art is schematically illustrated. FIG. 1a depicts a three-dimensional optical component 1, in particular an ophthalmic lens. FIGS. 1b and 1 c show XXX along the x-z-plane of the optical component 1. In current printing methods, the three-dimensional shape of an optical component 1, in particular an ophthalmic lens, is virtually sliced into two-dimensional slices. The optical component 1 is then built up in multiple printing steps. During each printing step, droplets of printing ink are ejected from the nozzles of a print head of an, preferably inkjet, printer. The droplets are preferably ejected towards a substrate. Through the ejection, droplets of printing ink are placed at least partially side by side such that a layer is formed. For each slice, a layer of printing ink is deposited. In this way, the three-dimensional optical component 1 is built up through a targeted placement of droplets of printing ink from layers of printing ink. Preferably, the printing ink is transparent or translucent. The printing ink comprises multiple components of which at least one is a photo-polymerizable monomer. The deposited droplets are preferably at least partially cured at intervals. During curing, the deposited droplets are preferably exposed to radiation, particular preferably of UV light. Through curing, the viscosity of the deposited printing ink is increased and the deposited droplets pinned to their location. The degree of pinning depends on the particulars of the curing step, e.g. the intensity and/or wave length of the used radiation and/or the exposure time. When printing three-dimensional optical components 1 with sharp edges 2, deviations between the intended and resulting, printed shape result, see FIG. 1b for the intended shape and FIG. 1c for the actual shape. The printing plane lies in the x-y-plane, whereas the direction of flight of the deposited droplets is mainly in the z-direction. The exhibited deviations are caused by the fluid characteristics of the deposited printing ink. In particular, unwanted deformations in the form of bulges 4 or protrusions form. This is particular detrimental in the printing of ophthalmic lenses. Ophthalmic lenses usually exhibit a sharp edge 2 formed by the points of contact of the circumferential, during print vertical, section 3 of the lens and its curved, concave or convex, surface (not shown). With state of the art printing methods, such a sharp edge 2 and hence a high-quality ophthalmic lens cannot be printed. The quality of the print is compromised by the resulting bulge 4 formed at the edge 2.

In FIGS. 2a and 2b a printing method according to an exemplary embodiment of the present invention is schematically illustrated. The printing method according to an exemplary embodiment of the present invention differs from the state of the art methods in that the printing of the three-dimensional component 1 is divided into a boundary defining step during which a defined boundary is provided and a filling step during which the volume adjoining that boundary 5 is filled. This two-step procedure can either be carried out layer by layer, see FIG. 2b, for a section of the optical component 1 or for the whole component 1, see FIG. 2a. The optical component 1 comprises a boundary portion 5 and a remaining portion 6. The boundary portion 5 is chosen such that it contains the critical portions of the optical component 1. Preferably, the boundary portion 5 comprises the sharp edge 2 of the optical component 1. The boundary portion preferably additionally comprises the steep section 3. E.g. for an optical component 1 that is an ophthalmic lens, the steep section 3 comprises the circumferential section of the ophthalmic lens that extends mainly in the z-direction. Preferably, the boundary portion 5 at least partially surrounds the remaining portion 6. For example, the boundary portion 5 comprising the edge 2 and the circumferential steep section 3 completely surrounds the remaining portion 6. According to an exemplary embodiment, the boundary portion 5 is printed in a boundary defining step and subsequently the remaining portion 6 is printed during the filling step. Hence, the boundary portion 5 printed prior to the remaining portion 6 provides a defined boundary for the remaining portion 6. The defined boundary advantageously prevents the formation of unwanted bulges and protrusions at the edge 2 of the optical component 1. In an alternative embodiment, the two-step procedure is carried out layer by layer, see FIG. 2b. In particular, at least one layer 7 of the optical component 1 is printed such that a boundary area 8 is deposited during a boundary defining step and a remaining area 9 is printed during a filling step. The boundary area 8 and the remaining area 9 are defined by the areas of the layer 7 lying inside the boundary portion 5 and remaining portion 6 of the optical component 1, respectively. In this way, a defined boundary is provided inside the at least one layer 7. Preferably, the boundary defining step and filling step are carried out for each layer 7 being part of either the boundary portion 5 and/or the remaining portion 6. By providing a defined boundary on a per layer basis, detrimental fluid characteristics of the deposited printing ink are avoided and hence the formation of bulges 4 prevented. Preferably, the deposited droplets of printing ink are cured through irradiation, e.g. with UV light. The curing properties used for curing of boundary and remaining portion 5, 6 (boundary area and remaining area 8, 9, respectively) preferably differ. E.g. the boundary portion 5 and boundary area 8 are cured using a higher curing energy than the remaining portion 6 and remaining area 9. Hence, a stable boundary is provided. This is, for example, achieved through curing the boundary and the remaining portion 5, 6 (boundary area and remaining area 8, 9, respectively) in separate curing steps using differing curing properties. Alternatively, UV light of locally varying intensity may be used during curing. E.g. the intensity at the boundary portion 5 is higher than at the remaining portion 6. Further, the printing properties during the boundary defining step preferably differ from the printing properties of the filling step. Printing properties comprise for example printing speed and deposited printing ink. Preferably, the printing properties are chosen such as to optimize the defined boundary. Additionally or alternatively, a time span elapses between the boundary defining step and the filling step during which the chemical and/or physical properties of the printing ink deposited during the boundary defining step are altered. For example, diffusion takes place and/or the viscosity of the deposited printing ink increases. Dividing the printing process such that a defined boundary is provided during a boundary defining step before the adjoining volume is filled during a filling step, advantageously prevents the formation of bulges 4 and protrusions through detrimental fluid characteristics of the deposited printing ink. Hence, an optical component 1, in particular an ophthalmic lens, of increased quality is provided.

In Figures a and 3b a printing method according to an exemplary embodiment of the present invention is schematically illustrated. The printing method according to an exemplary embodiment of the present invention differs from the state of the art methods in that a boundary portion 5 of the three-dimensional component 1 and an inner portion 10 of the three dimensional component 1 is printed layer by layer, wherein a first layer of the boundary portion 5 is printed after printing one or more layers of the inner portion 10.

Here, a first layer of the inner portion 10 is printed in a first inner portion printing step A. Here, the first inner portion layer printing step A is followed by a second inner portion layer printing step B, a third inner portion layer printing step C, a fourth inner portion layer printing step D, a fifth inner portion layer printing step E, and a sixth inner portion layer printing step F. The sixth layer printing step F is followed by a first boundary printing step G, wherein the first layer of the boundary portion 5 and the seventh layer of the inner portion 10 are printed. Posterior to the first boundary layer printing step G, subsequent layers of the inner portion 10 and subsequent layers of the boundary portion 5 are printed in subsequent steps H-P.

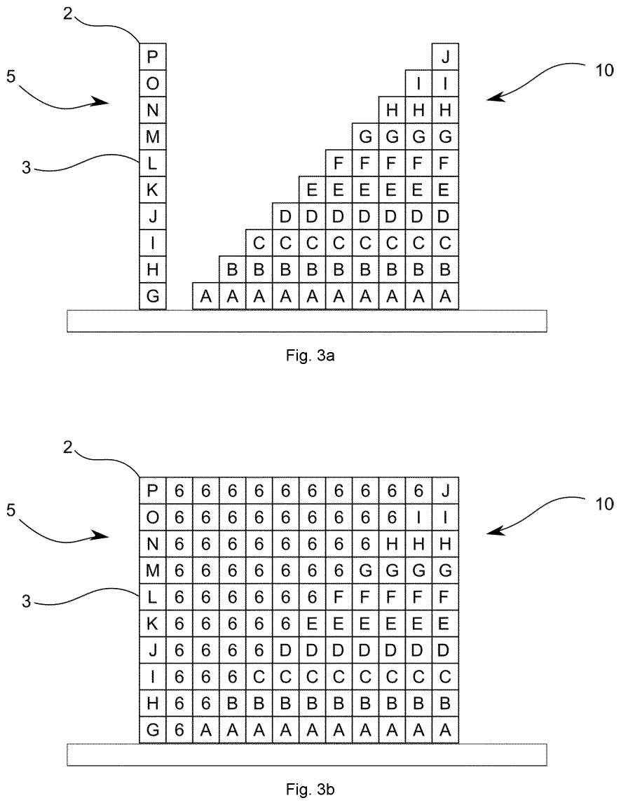

After the boundary portion 5 and the inner portion 10 have been printed, the space between the boundary portion 5 and the inner portion 10 is filled by printing the remaining portion 6 (see FIG. 3b)

Preferably, the boundary portion 5 comprises the sharp edge 2 of the optical component 1. The boundary portion 5 preferably additionally comprises the steep section 3. E.g. for an optical component 1 that is an ophthalmic lens, the steep section 3 comprises the circumferential section of the ophthalmic lens that extends mainly in the z-direction. Preferably, the boundary portion 5 at least partially surrounds the remaining portion 6. For example, the boundary portion 5 comprising the edge 2 and the circumferential steep section 3 completely surrounds the remaining portion 6.

Preferably, the boundary portion 5 printed prior to the remaining portion 6 and thus provides a defined boundary for the remaining portion 6. The defined boundary advantageously prevents the formation of unwanted bulges and protrusions at the edge 2 of the optical component 1. Preferably, the deposited droplets of printing ink are cured through irradiation, e.g. with UV light. The curing properties used for curing of boundary portion 5, the inner portion 10 and remaining portion 6 preferably differ. E.g. the boundary portion 5 is cured using a higher curing energy than the remaining portion 6 or the inner portion 10. Hence, a stable boundary is provided. This is, for example, achieved through curing the boundary portion 5, the inner portion 10 and the remaining portion 5 in separate curing steps using differing curing properties. Alternatively, UV light of locally varying intensity may be used during curing. E.g. the intensity at the boundary portion 5 is higher than at the remaining portion 6. Further, the printing properties during printing the boundary portion 5, the inner postion 10 and/or the remaining portion 6 preferably differ from each other. Printing properties comprise for example printing speed and deposited printing ink. Preferably, the printing properties are chosen such as to optimize the defined boundary. Additionally or alternatively, time span elapses between the subsequent steps and the filling step during which the printing ink deposited during the subsequent steps changes its chemical and/or physical properties. For example, diffusion takes place and/or the viscosity of the deposited printing ink increases.

### KEY TO FIGURES

1 Optical component
2 Edge
3 Steep section
4 Bulge
5 Boundary portion
6 Remaining portion
7 Layer
8 Boundary area
9 Remaining area
10 Inner portion
A first inner portion layer printing step
B second inner portion layer printing step
C third portion layer printing step
D fourth inner portion layer printing step
E fifth inner portion layer printing step
F sixth inner portion layer printing step
G first boundary printing step
H-P subsequent steps

1. A method for printing a three-dimensional optical component, in particular an ophthalmic lens, comprising a boundary portion and a remaining portion, comprising the following steps:
building up the three-dimensional component from layers of printing ink, wherein each layer is obtained through a targeted placement of droplets of printing ink at least partially side by side;
wherein the boundary portion of the three-dimensional component is printed during a boundary defining step followed by a filling step during which the remaining portion is printed and thus a volume adjoining the boundary portion is filled; and
wherein the boundary defining step and the filling step are carried out layer by layer.

2. The method according to claim 1, wherein the three-dimensional optical component is an ophthalmic lens, wherein the optical component comprises the boundary portion and the remaining, portion, wherein the method comprises the following steps:
virtually slicing the three-dimensional optical component into two-dimensional slices;
building up the three-dimensional component from layers of printing ink corresponding to these slices, wherein each layer is obtained through a targeted placement of droplets of printing ink at least partially side by side;
wherein at least one slice comprises a boundary area and a remaining area constituted by areas of the at least one slice forming part of the boundary portion and remaining portion, respectively;
wherein the boundary area of the layer corresponding to the at least one slice is printed during the boundary defining step followed by the filling step during which the remaining area of the layer corresponding to the at least one slice is printed.

3. The method according to claim 2, wherein the boundary defining step and the filling step are repeated for all layers corresponding to slices forming part of the boundary portion and/or the remaining portion.

4. The method according to claim 1, wherein the boundary portion comprises an edge.

5. The method according to claim 1, wherein the boundary portion comprises a steep section.

6. The method according to claim 1, wherein the boundary portion at least partially surrounds the remaining portion.

7. The method according to claim 1, wherein the deposited droplets of printing ink are at least partially cured using UV light.

8. The method according to claim 7, wherein at least part of the boundary portion is cured using a higher curing energy than at least part of the remaining portion.

9. The method according to claim 7, wherein the deposited droplets are cured using UV light of locally varying intensity.

10. The method according to claim 1, wherein printing properties of the boundary defining step differ from the printing properties of the filling step.

11. The method according to claim 1, wherein a defined time span elapses between the boundary defining step and the filling step during which the printing ink deposited during the boundary defining step changes its chemical and/or physical properties.

12.-23. (canceled)

24. The method according to claim 5, wherein the steep section is vertical.
